(19) United States
(12) Patent Application Publication
(10) Pub. No.: US 2010/0122994 A1
(43) Pub. Date: May 20, 2010

(54) Connecting Device for Equipping a Container on a Bicycle

(76) Inventor: Louis Chuang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/273,616

(22) Filed: Nov. 19, 2008

(51) Int. Cl. B62J 7/06; B62J 11/00

(52) U.S. Cl. 224/420; 224/547; 224/558; 403/256; 248/311.2; 248/214

(57) ABSTRACT

A connecting device includes a fixture having a through slot, a block having a compartment connected to and in communication with the through slot, a neck, a hooking base extending from the neck, and a controller moveably mounted in the compartment and including a first engaging portion extending out of the through slot and being operable to move into the through slot. A connecting body is releasably mounted to the fixture and including a first end and a second end, a first groove and a second groove. When the connecting body is joined with the fixture, the hooking base is received in the first groove and the neck is received in the second groove and the first engaging portion of the controller protrudes on the first end of the connecting body for secure and stable engagement therebetween.

### BACKGROUND OF THE INVENTION

1. Field of the Invention

The present invention relates to a connecting device, in particular, to a connecting device which can be implemented in a bicycle and which can be utilized to equip an accessory, like a container, on the bicycle and in a quick-releasable manner.

2. Description of the Related Art

TW Pat. No. 408,731 teaches a connecting device which can be implemented in a bicycle and which can be utilized to equip a container to the bicycle and in a releasable manner. The connecting device includes a fixture which is adapted to be mounted on a head tube of the bicycle and a connecting plate which is adapted to be fixed on the bracket and which is releasably connected with the fixture. Further, a controller includes an engaging portion which selectively engages in a recess defined in the connecting plate such that when the connecting plate is engaged in the recess the connecting plate can not be disengaged from the fixture and while when the connecting plate is not engaged in the recess the connecting plate can be disengaged from the fixture. Nevertheless, the present invention is intended to provide a connecting device which allows a container to be more securely and stably mounted on a bicycle and which facilitates operation thereof.

### SUMMARY OF THE INVENTION

According to the present invention, a connecting device includes a fixture having a through slot, a block having a compartment connected to and in communication with the through slot, a neck, a hooking base extending from the neck, and a controller moveably mounted in the compartment and including a first engaging portion extending out of the through slot and being operable to move into the through slot. Further, a connecting body is releasably mounted to the fixture and including a first end and a second end, a first groove and a second groove.

Preferably, the fixture is releasably mounted on the head tube.

Preferably, the connecting body is mounted to the container.

Preferably, when the connecting body is joined with the fixture, the hooking base is received in the first groove and the neck is received in the second groove and the first engaging portion of the controller protrudes on the first end of the connecting body for allowing a secure and stable engagement therebetween.

### BRIEF DESCRIPTION OF THE DRAWINGS

FIG. 1 is a perspective view of a connecting device in accordance with the present invention, with the connecting device being mounted on a head tube of a bicycle and being utilized to equip a container to the bicycle, and with the head tube shown in portion.

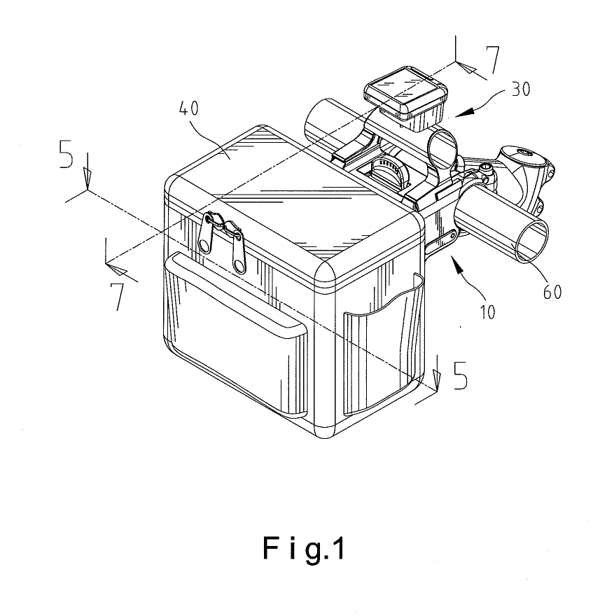

FIG. 2 is another perspective view of FIG. 1, showing the container is detached from the bicycle.

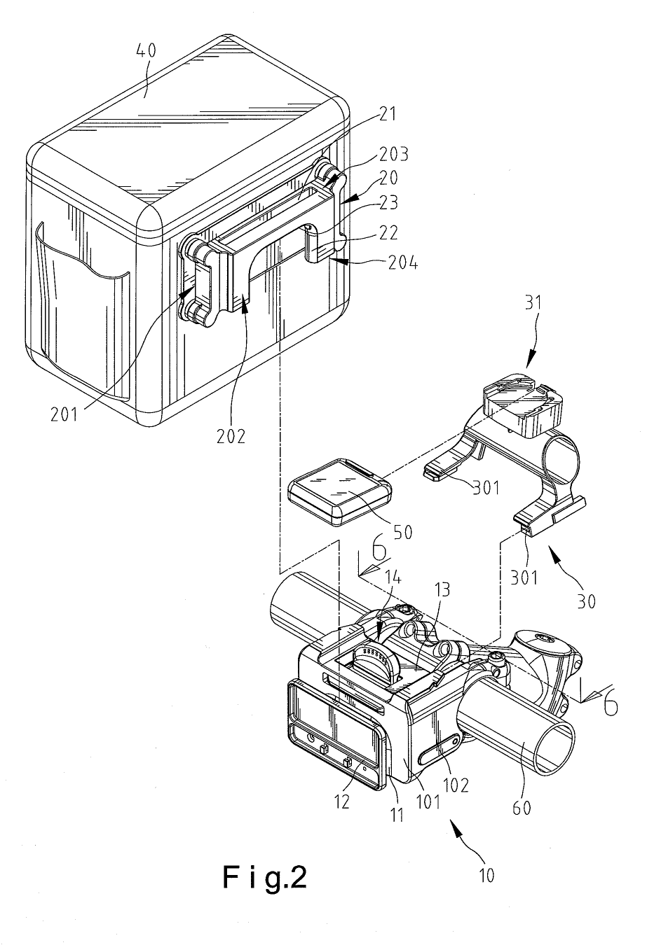

FIG. 3 is an exploded perspective view of a fixture of the connecting device shown in FIG. 1.

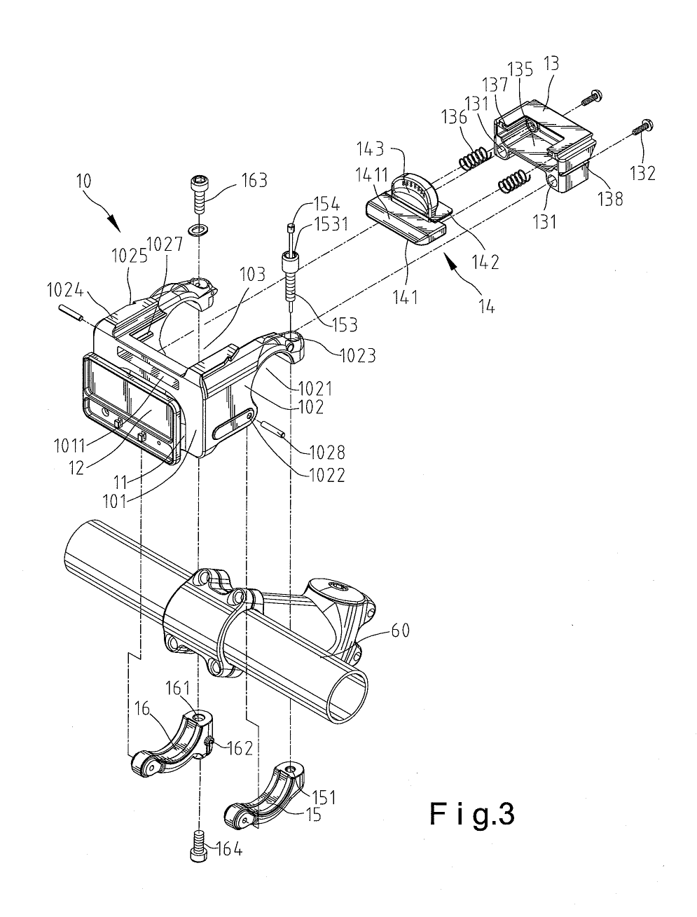

FIG. 4 is another exploded perspective view of a fixture of the connecting device shown in FIG. 1, but in a different view angle.

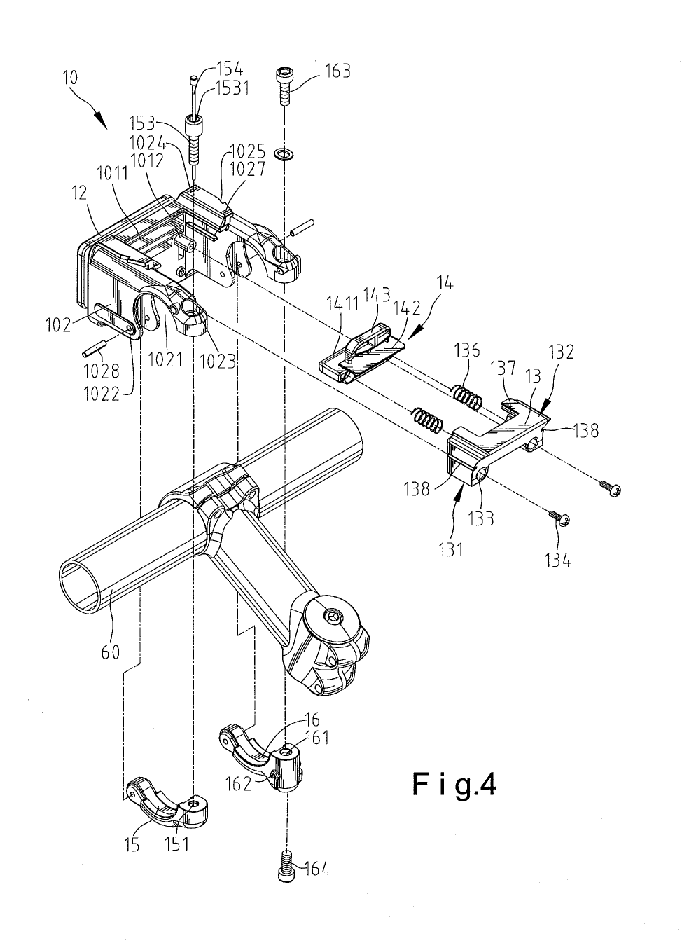

FIG. 5 is a cross-sectional view of line 5-5 in FIG. 1.

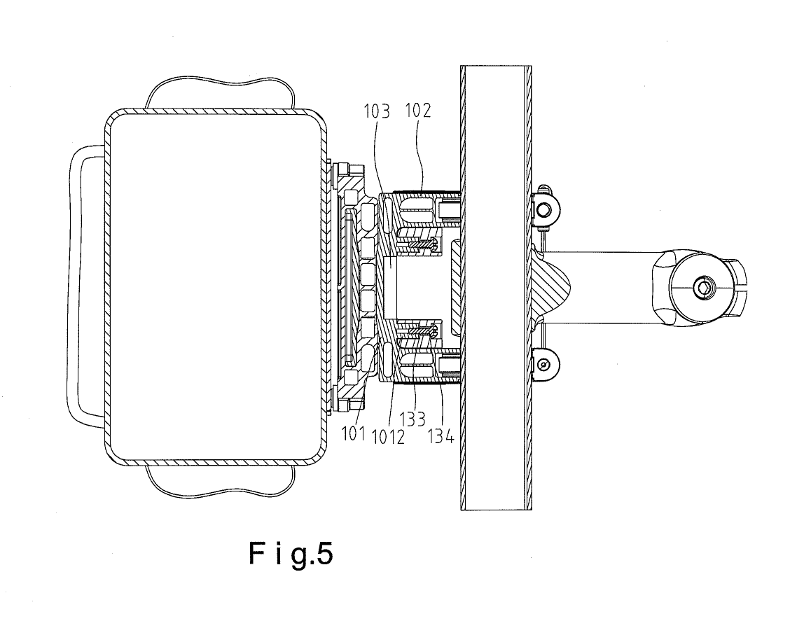

FIG. 6 is a cross-sectional view of line 6-6 in FIG. 2

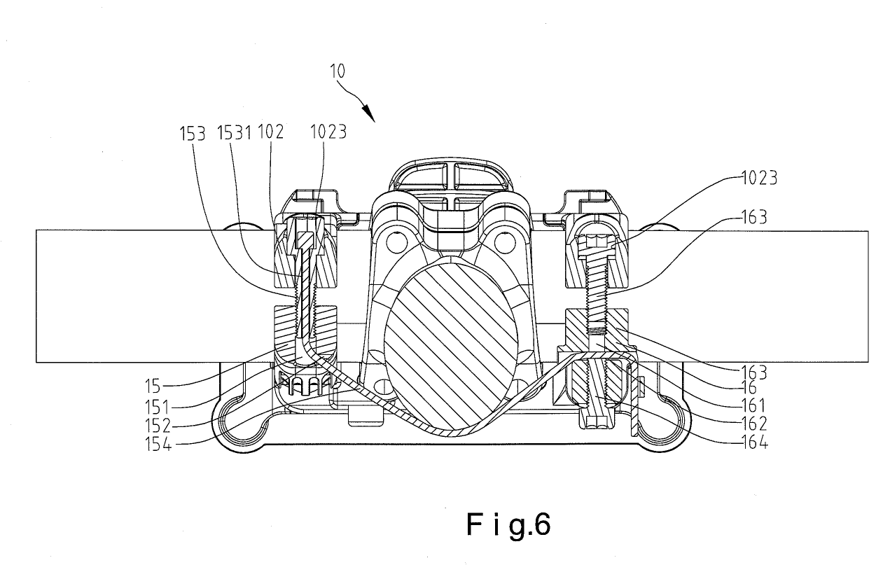

FIG. 7 is a cross-sectional view of line 7-7 in FIG. 1

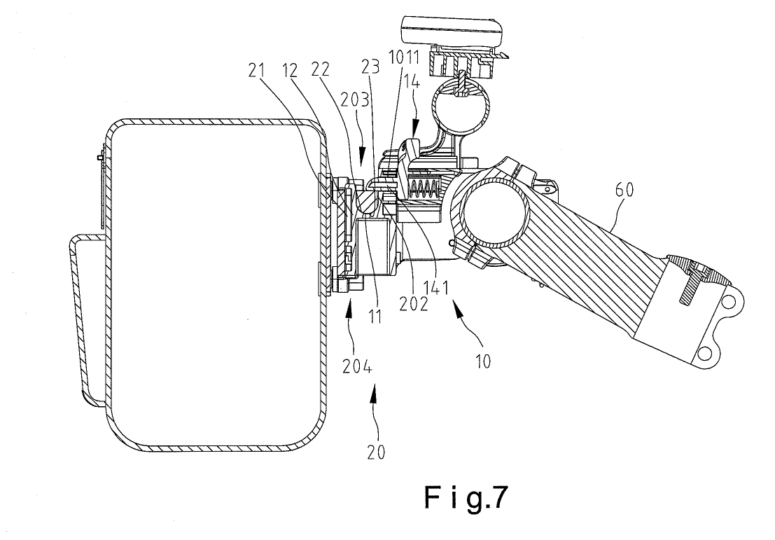

FIG. 8 is a cross-sectional view similar to FIG. 7 and illustrates operation of the connecting device shown in FIG. 1 and removal of the container from the bicycle.

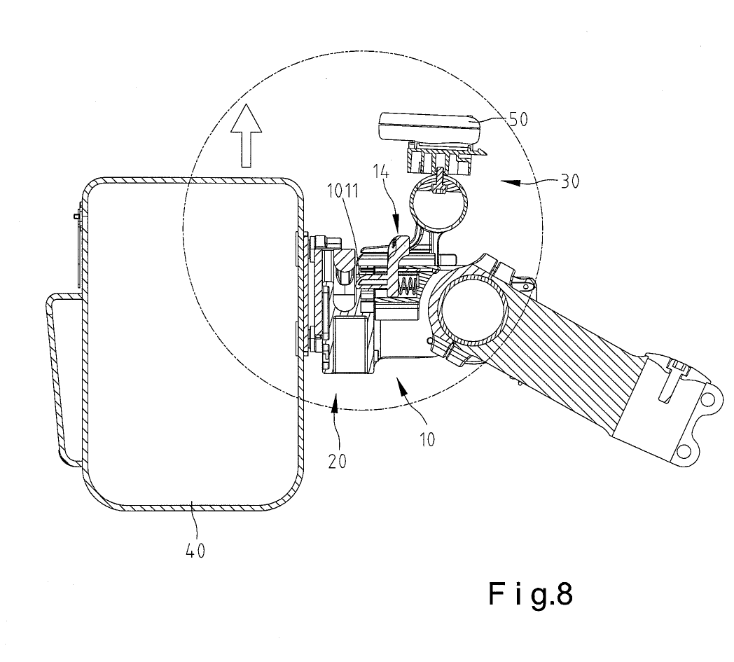

FIG. 9 is a partial, enlarged view of FIG. 8.

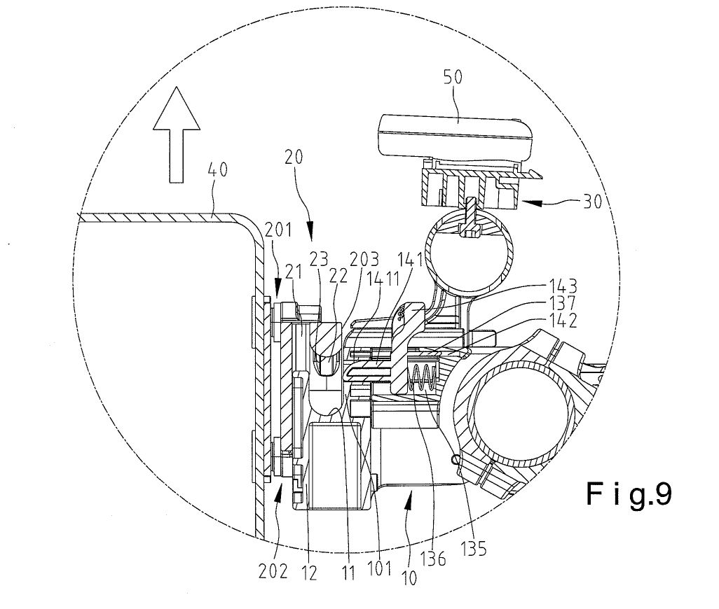

### DETAILED DESCRIPTION OF THE PREFERRED EMBODIMENT

Referring to the drawings, a connecting device includes a fixture 10 having two arms 102 and each of the arms 102 has a cavity 1021 for receiving a head tube 60 of a bicycle. The fixture 10 further includes a first side 101 in which the two arms 102 is extended from a proximal end and a distal end thereof respectively, with the first side 101 and two arms 102 connected contiguously and forming a substantially U-shaped space 103.

The first side 101 includes a first surface and a second surface opposite to the first surface. Further, the first side 101 includes a through slot 1011 extending through first and second surfaces thereof, a neck 11 and a hooking base 12 extending from the first face thereof, with the hooking base 12 extending from and connected contiguously to the neck 11, and two protrusions 1012 extending from the second face thereof.

The fixture 10 also includes a block 13 which is connected to the second surface of the first side 101 thereof. The block 13 includes two through holes 131 in which the two protrusions 1012 are received and is prevented from disengagement by means of two fasteners 132 engaging the two protrusions 1012, respectively, and yet, in order that the block 13 is firmly and stably engaged with the fixture 10 as the two arms 102 includes two rails 1027 and the block 13 includes two second channels 138, with the two rails 1027 being received in the two channels 138 respectively.

The block 13 also includes a compartment 135 which is connected to and in communication with the through slot 1011 and in which a controller 14 is moveably mounted. The controller 14 includes a first engaging portion 141 which is substantially tapered and has a proximal end connected to the controller 14 and a distal end and a substantially arcuate guiding plane 1411 extending from the proximal end to the distal end, and which extends out of the through slot 1011 and is operable to move into the through slot 1011. Further, a second engaging portion 142 extends opposite to the first engaging portion 141 and moveably engages with the block 13 so as to enable the controller 14 move stably in the compartment 135. Specifically, the block 13 includes two first channels 137 and the second engaging portion 142 has a proximal end received in one of the two channels 137 and a distal end received in another of the two channels 137, respectively. Further, a handle 143 extends transverse to the first and second engaging portions 141, 142 is utilized for user to operate the controller 14. Preferably, the compartment 135 includes an opening and the handle 143 extends out of the opening so as to allow the handle 143 to be gripped readily by the user. Moreover, two resilient members 136 are installed between the block 13 and the controller 14 so that a return movement of the controller 14 is adapted to be facilitated.

A connecting body 20 is releasably mounted to the fixture 10 and can be utilized to equip a container 40 to the bicycle. The connecting body 20 includes a first side 201 attached to the container 40 and a second side 202. Moreover, the connecting body 20 includes a first end 203 and a second end 204 opposite to the first end 203, a first groove 21 for receiving the hooking base 12 and a second groove 22 for receiving the neck 11. Preferably, the first groove 21 extends from the first end 203 to the second end 204 of the connecting body 20. Preferably, the second groove 22 extends from a stopping edge 23 defined by the connecting body 20 to the second end 204 of the connecting body 20 and therefore has a first end delimited by the stopping edge 23 and an open second end. Preferably, the stopping edge 23 has a first side coinciding with the first end 203 of the connecting body 20 and a second side opposite to the first side and coinciding with the first end of the second groove 22.

The connecting device further includes a first clutching member 15 having a first end connected to one of the two arms 102 and a second end pivotal in relation to the first end and a second clutching member 16 having a first end connected to another of the two arms 102 and a second end pivotal in relation to the first end. In this embodiment, the first and second clutching members 15 and 16 have their second ends which can pivot with respect to the their first ends in that each of the two arms 102 includes a pivot hole 1022 formed thereon and a pin 1028 is utilized to insert through the first clutching member 15 and the pivot hole 1022.

Additionally, each of the two arms 102 includes a through hole 1023, and the first clutching member 15 includes a first hole 151 at the second end thereof as well as the second clutching member 16 includes a first hole 161 at the second end thereof respectively. Then, a first fastening member 153 which is insertable in the through hole 1023 in one of the two arms 102 and the first hole 151 in the first clutching member 15 and a second fastening member 163 which is insertable in the through hole 1023 in another of the two arms 102 and the first hole 161 in the second clutching member 16. Therefore, the head tube 60 is securely held within the two cavities 1028 of the two arms 102.

Further, the first clutching member 15 includes a second hole 152 connected to and in communication with the first hole 151, and the second clutching member 16 includes a second hole 162 connected to and in communication with the first hole 161. A tightening string 154, preferably made of steel, is inserted through a through hole 1531 defined in the first fastening member 153 and the first and second holes 151 and 152 in the first clutching member 15, is passed under the head tube 60, and is inserted through the first and second holes 161 and 162 in the second clutching member 16 for allowing a secure and stable engagement between the fixture 10 and the head tube 60. Moreover, the tightening string 154 may be tightened under tension and prevented from slacking by a third fastening member 164.

Based on the forgoing, it is therefore appreciated that when the connecting body 20 is joined with the fixture 10 the hooking base 12 is received in the first groove 21 and the neck 11 is received in the second groove 22 and the first engaging portion 141 of the controller 14 protrudes on the first end 203 of the connecting body 20 for secure and stable engagement therebetween. Moreover, it is appreciated that the connecting body 20 can be engaged and with the fixture 10 easily and with one hand, as the first engaging portion 141 of the controller 14 and the stopping edge 23 have their coacting surfaces being substantially arcuate or tapered. Moreover, it is required two hands of a user to disengage the connecting body 20 from the fixture 10, as the connecting body 20 and the fixture 10 are securely engaged in a reliable manner.

It is yet another aspect of the present invention that each of the two arms 102 includes a joint 1024 for receiving an adaptor 30 that is adapted for receiving a bicycle accessory 50, such as a stop watch, a torch and so on. Each joint 1024 includes a hook 1025 for secure holding the adaptor 30. In this embodiment, the adaptor 30 has two legs 301 which releasably connectable to the two joints 1024 respectively and a quick-releasable connector 31. Since the quick-releasable connector 31 has a known mechanism, the quick-releasable connector 31 is thus not further described.

While the specific embodiments have been illustrated and described, numerous modifications come to mind without significantly departing from the spirit of invention and the scope of invention is only limited by the scope of accompanying claims.

What is claimed is:

1. A connecting device which can be implemented in a head tube of a bicycle and which can be utilized to equip a container on the bicycle comprising:
a fixture including a first side having a through slot, a block having a compartment connected to and in communication with the through slot, a neck extending from the first side, a hooking base extending from the neck, and a controller moveably mounted in the compartment and including a first tapered engaging portion extending out of the through slot and being operable to move into the through slot;
a connecting body releasably mounted to the fixture and including a first end and a second end opposite to the first end, a first groove for receiving the hooking base and a second groove for receiving the neck; and
wherein the fixture is releasably mounted on the head tube, and wherein the connecting body is mounted to the container, and wherein when the connecting body is on the process of engaging the fixture the first engaging portion is utilized to facilitate the connecting body joined with the fixture by user with one hand, and wherein when the connecting body is joined with the fixture the hooking base is received in the first groove and the neck is received in the second groove and the first engaging portion of the controller protrudes on the first end of the connecting body for secure and stable engagement therebetween.

2. The connecting device as claimed in claim 1 wherein the second groove includes a first end and a second end, and wherein the connecting body includes a stopping edge having a first side coinciding with the first end of the connecting body and a second side opposite to the first side and coinciding with the first end of the second groove.

3. The connecting device as claimed in claim 2 wherein the first engaging portion includes a proximal end connected to the controller and a distal end and a substantially arcuate guiding plane extending from the proximal end to the distal end.

4. The connecting device as claimed in claim 1 wherein the fixture includes two arms extending from a proximal end and a distal end of the first side respectively, with the first side and two arms connected contiguously and forming a substantially U-shaped space.

5. The connecting device as claimed in claim 4 further comprising a resilient member installed between the block and the controller.

6. The connecting device as claimed in claim 5 wherein the block includes two first channels, and wherein the controller includes a second engaging portion extending opposite to the first engaging portion and having a proximal end received in one of the two channels and a distal end received in another of the two channels respectively.

7. The connecting device as claimed in claim 6 wherein the block includes two second channels, and wherein the two arms includes two rails respectively, and wherein the two rails are received in the two channels respectively.

8. The connecting device as claimed in claim 7 wherein the compartment includes an opening, and wherein the controller includes a handle extending out of the opening.

9. The connecting device as claimed in claim 4 further comprising a first clutching member having a first end connected to one of the two arms and a second end pivotal in relation to the first end, and a second clutching member having a first end connected to another of the two arms and a second end pivotal in relation to the first end, and wherein each of the two arms includes a through hole, and wherein the first clutching member includes a first hole at the second end and the second clutching member includes a first hole at the second end respectively, and wherein the connecting device further comprising a first fastening member inserting in the through hole in one of the two arms and the first hole in the first clutching member and a second fastening member inserting in the through hole in another of the two arms and the first hole in the second clutching member.

10. The connecting device as claimed in claim 9 wherein the first clutching member includes a second hole connected to and in communication with the first hole, and wherein the second clutching member includes a second hole connected to and in communication with the first hole, and the connecting device further comprising a tightening string inserting through the first fastening member and the first and second holes in the first clutching member, passing under the head tube, and inserting through the first and second holes in the second clutching member.

11. The connecting device as claimed in claim 1 wherein each of the two arms includes a joint, and wherein the connecting device further comprising an adaptor having two legs releasably connectable to the two joints respectively, and with the adaptor adapted for receiving a accessory.
